(19) United States
(12) Patent Application Publication
(10) Pub. No.: US 2025/0134640 A1
(43) Pub. Date: May 1, 2025

(54) ANIMAL POSITIONING AND MONITORING SYSTEM FOR MICROSCOPY

(71) Applicant: Northeastern University, Boston, MA (US)

(72) Inventors: Mohammad Yaseen, Boston, MA (US); Yuntao Li, Boston, MA (US)

(21) Appl. No.: 18/927,310

(22) Filed: Oct. 25, 2024

Related U.S. Application Data
(60) Provisional application No. 63/545,819, filed on Oct. 26, 2023.

(51) Int. Cl. A61D 3/00; A61D 13/00; A61D 99/00; G02B 21/00; G02B 21/24

(52) U.S. Cl. CPC A61D 3/00; A61D 13/00; A61D 99/00; G02B 21/0004; G02B 21/24; A61D 2003/003

(57) ABSTRACT

A system for positioning and monitoring an animal during microscopy may include a base supporting the animal, a head holder attached to the base and securing the animal's head, a body holder attached to the base and restraining the animal's body, at least one sensor measuring a physiological parameter of the animal, and a controller receiving and processing data from the at least one sensor. The base may comprise a scissor lifting jack for height adjustment. The head holder may include a ball joint for angular adjustment. The body holder may comprise a swaddle. Sensors may include an accelerometer to detect motion and a thermocouple to measure cranial window temperature. The system may also include a camera to capture images during microscopy.

### CROSS-REFERENCE TO RELATED APPLICATIONS

This application claims priority to U.S. Application No. 63/545,819, titled “PHYSIOLOGY AND BEHAVIOR MONITOR FOR INTRAVITAL IMAGING IN SMALL MAMMALS,” filed Oct. 26, 2023, which is hereby incorporated by reference in its entirety.

### GOVERNMENT SUPPORT

This invention was made with government support under Grant No. R01 AA027097 awarded by the National Institutes of Health. The government has certain rights in the invention.

### FIELD OF INVENTION

The present disclosure relates to devices and methods for positioning and monitoring animals during microscopy experiments, and more particularly to a system for restraining and imaging awake mice using two-photon microscopy while simultaneously measuring physiological parameters.

### BACKGROUND

Two-photon microscopy is a powerful technique for imaging living tissue, allowing researchers to visualize cellular and vascular structures deep within the brain of animals (e.g., mice). This method relies on the simultaneous absorption of two photons to excite fluorescent molecules, providing superior depth penetration and reduced photodamage compared to traditional fluorescence microscopy. However, performing two-photon microscopy on awake animals presents significant challenges related to motion artifacts and proper positioning of the subject.

Existing systems for restraining and positioning mice during two-photon imaging experiments often suffer from limitations that can impact data quality and animal welfare. Common issues include excessive setup times, inadequate immobilization leading to motion artifacts, and designs that induce stress in the animal. Additionally, many current setups lack the ability to simultaneously monitor physiological parameters like body temperature, heart rate, and breathing, which are important for assessing the animal's state during imaging.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for positioning and monitoring a small animal during microscopy is provided. The system may include a base supporting other components of the system. The system may include a head holder attached to the base and securing the animal's head. The system may include a body holder attached to the base and restraining the animal's body. The system may include at least one sensor measuring a physiological parameter of the animal. The system may include a controller receiving and processing data from the at least one sensor.

According to other aspects of the present disclosure, the system may include one or more of the following features. The base may comprise a scissor lifting jack. The scissor lifting jack may enable the height of the animal relative to a surface upon which the system rests and/or relative to a microscopy system. The head holder may comprise a ball joint allowing angular adjustment of the animal's head position. The body holder may comprise a swaddle comfortably restraining the animal's body. The at least one sensor may comprise an accelerometer detecting motion of the animal. The at least one sensor may comprise a thermocouple measuring the temperature of the animal's cranial window. The system may further comprise a camera capturing images of the animal during microscopy.

According to another aspect of the present disclosure, a method for imaging an awake, small animal using two-photon microscopy is provided. The method may include positioning the animal in a restraint device comprising a base, a head holder, and a body holder. The method may include securing the animal's head with the head holder. The method may include restraining the animal's body with the body holder. The method may include measuring at least one physiological parameter of the animal using at least one sensor. The method may include performing two-photon microscopy imaging on the animal while simultaneously monitoring the at least one physiological parameter.

According to other aspects of the present disclosure, the method may include one or more of the following features. Measuring the at least one physiological parameter may comprise measuring the temperature of the animal's cranial window using a thermocouple. The method may further comprise adjusting the height of the base to position the animal's cranial window at a desired distance from a microscope objective. Adjusting the height of the base may comprise operating a scissor lifting jack. Measuring the at least one physiological parameter may comprise detecting motion of the animal using an accelerometer. The method may further comprise excluding microscopy data acquired during periods of excessive animal motion based on accelerometer readings. The method may further comprise capturing video of the animal during microscopy imaging using at least one camera.

According to another aspect of the present disclosure, a device for restraining and monitoring a small animal during microscopy is provided. The device may include a cradle supporting the animal's body. The device may include a head holder securing a cranial window on the animal's skull. The cranial window may be covered with a glass coverslip. The device may include an adjustable stage connected to the cradle and the head holder, the adjustable stage may provide multi-axis positioning. The device may include at least one sensor integrated with the device and measuring a physiological parameter of the animal during microscopy.

According to other aspects of the present disclosure, the device may include one or more of the following features. The adjustable stage may comprise a scissor lifting jack. The scissor lifting jack may be configured to adjust a vertical position of the animal. The at least one sensor may comprise an accelerometer. The accelerometer may be configured to detect motion of the animal. The at least one sensor may further comprise a thermocouple measuring the temperature of the cranial window. The device may further comprise at least one camera capturing images or video of the animal during microscopy. The at least one camera may comprise an infrared camera monitoring pupil dilation of the animal.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts an exemplary system for positioning an animal for imaging, in accordance with one or more embodiments of the present disclosure.

FIG. 2 depicts an exemplary system for positioning an animal for imaging, in accordance with one or more embodiments of the present disclosure.

FIG. 3 depicts an exemplary system for conducting imaging experiments of an animal, in accordance with one or more embodiments of the present disclosure.

FIG. 4 depicts an exemplary system for positioning an animal for imaging, in accordance with one or more embodiments of the present disclosure.

FIG. 5 depicts a schematic diagram for an exemplary device for positioning an animal for imaging, in accordance with one or more embodiments of the present disclosure.

FIG. 6 depicts an exemplary flow diagram for synchronizing data acquisition during imaging of an animal, in accordance with one or more embodiments of the present disclosure.

FIG. 7 depicts an exemplary system for positioning and monitoring animals during microscopy experiments, in accordance with one or more embodiments of the present disclosure.

FIG. 8 depicts results of a validation test of one or more of the systems described herein.

FIG. 9 depicts results of a validation test of one or more of the systems described herein.

### DETAILED DESCRIPTION

The following description sets forth exemplary aspects of the present disclosure. It should be recognized, however, such description is not intended as a limitation on the scope of the present disclosure. Rather, the description also encompasses combinations and modifications to those exemplary aspects described herein.

The present disclosure provides systems and methods for effectively positioning and monitoring animals during microscopy experiments, particularly those involving two-photon microscopy. In some implementations, the animals may be small animals (e.g., mice). Although the systems and methods are described herein primarily with reference to two-photon microscopy, this is not intended to be limiting. The systems and methods described herein may be effective in restraining animals during PET scans, MRI scans, and/or other forms of imaging. These systems and methods may comprise and/or comprise the use of an imaging platform with an integrated data acquisition (DAQ) system and miniaturized sensors.

In some aspects, the system and methods disclosed herein may be used to perform two-photon microscopy imaging on an awake animal while simultaneously monitoring at least one physiological parameter of the animal. This simultaneous imaging and monitoring may provide valuable insights into the animal's physiological responses during the microscopy experiment, potentially enhancing the quality and interpretability of the imaging data.

The methods disclosed herein may involve positioning the animal in the restraint device, securing the animal's head with the head holder, restraining the animal's body with the body holder, and measuring physiological parameters of the animal using the sensors, all while performing two-photon microscopy imaging on the animal. These systems and methods may provide a more efficient and humane approach to conducting microscopy experiments on awake animals, potentially leading to more accurate and reliable research outcomes. In some implementations, the systems described herein may be designed to maintain the animal for a duration of one to two hours.

The imaging platform may feature a specially designed cradle that maintains greater comfort to the animal and simplifies positioning and immobilization of its head. The customized DAQ software may consolidate and synchronize recordings from 10 voltage lines and 2 cameras. The customized DAQ software may enable immediate review of the recordings. The data acquisition hardware may include miniaturized sensors (including at least 2 cameras). The miniaturized sensors may be operatively connected to a microcomputer. The entire platform may be portable and lightweight. The entire platform may conveniently fit within the small sample spaces of most commercial upright microscopes or other intravital optical imaging systems.

The systems and methods described herein may minimize animal distress, streamline and expedite the experimental setup process, and simplify data processing. These systems and methods may offer significant advantages in terms of reducing setup times, enhancing animal comfort, and improving the quality of imaging data. In various embodiments, the device may reduce setup time from 30-60 minutes to 3-5 minutes. The integrated platform and data acquisition system may significantly decrease time required for experimental setup. The integrated platform and data acquisition system may simplify data analysis procedures. The platform may reduce biological variability and increase throughput of experimental data. By reducing distress and enabling immediate review of the physiological data, experimental success rates are estimated to improve by at least 25%. In various embodiments, the platform can be utilized for designing several simple, yet very impactful, neuroscience studies.

The device may be based on an inexpensive, powerful microcomputer (e.g., an NVidia Jetson Nano, a Raspberry Pi controller) that records data from multiple sensors simultaneously. The sensors and microcomputer may be quickly positioned and mounted on to the imaging platform. In various embodiments, custom-written software features a graphical-user interface to display and record the sensor data. The recordings may be triggered by another system, ensuring synchronous recordings from the device's peripheral sensors and the imaging microscope data. The microcomputer may be operatively connected to the sensors. In some implementations, data measured by each of the sensors is processed by the same microcomputer.

In some implementations, the systems and methods described herein may enable set up of imaging experiments in less than 15 minutes. In some implementations, the set up may be completed in 15-30 minutes. In some implementations, the set up may be completed in more than 30 minutes. The duration of set up may be determined based on users trained to use the systems described herein. For example, a new user may take longer to set up the systems than a user who has used the system multiple times. The systems described herein may comprise materials with reflectivity of less than or equal to 0.5. In some implementations, the base and/or the head holder may not corrode when cleaned with 70% (or lower) ethyl alcohol and/or a disinfecting wipe. The systems described herein may be configured to hold a mouse weighing between 20 and 50 grams.

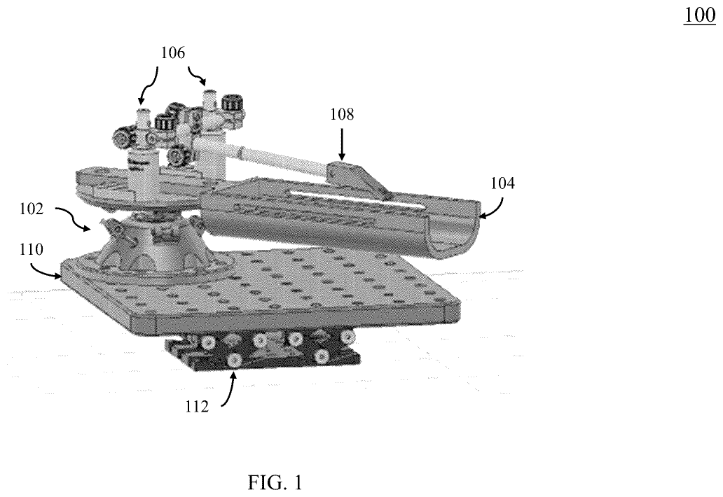

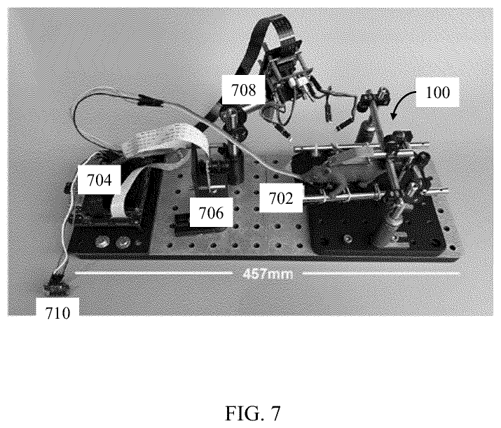

FIGS. 1-4 depict perspective views of a system 100 for positioning animals during microscopy experiments in accordance with embodiments of the present disclosure. FIG. 7 depicts a perspective view of a system 700 for positioning and monitoring animals during microscopy experiments in accordance with one or more embodiments of the present disclosure. System 700 may comprise system 100 as depicted in any of FIGS. 1-4. System 700 may include sensors that are specifically designed for animal imaging, all of which are recorded synchronously on a microcomputer. System 700 may comprise system 100. System 100 may comprise a base, a body holder, and a head holder. The base may comprise optical breadboard 110, scissor jack 112, and/or other components. The body holder may comprise cradle 104, scaffolding 102, and/or other components. The head holder may comprise scaffolding 106, head mount 108, and/or other components. Scaffolding 106 may be a mount supporting head mount 108. Scaffolding 106 may enable adjustment of the position of head mount 108. Scaffolding 106 may be operatively connected to scaffolding 102.

In some aspects, system 100 may include a base, a head holder for securing the animal's head, a body holder for restraining the animal's body, and/or other components. The head holder may attach to cranial window implanted in the animal. The head holder may be responsible for keeping the head immobilized. The body holder may be in contact with the animal's body. The body holder may be responsible for the animal's comfort. The body holder may be responsible for preventing the animal from applying force to the head holder. The base may be the interface between a surface (e.g., a table) and system 100. The base may allow height and/or other spatial adjustments, while also giving the user the ability to lock the device in place to preserve optimized positioning. The stimuli may be intended to elicit brain activity for imaging. In some implementations, no portion of the systems described herein obstruct the view of the cranial window for a microscope used during imaging.

### Body Holder

The body holder may be attached to the base to restrain the animal's body. The body holder may be designed to comfortably secure the animal's body, further reducing unwanted movement during the microscopy experiment. The body holder may be adjustable and may be designed to accommodate animals of different sizes and shapes. The body holder may include materials capable of resisting thermal degradation. The body holder may include non-reflective materials. The body holder may be sanitized using rubbing alcohol, disinfecting wipes, and/or other solutions. The body holder may comprise cradle 104 and scaffolding 102. Scaffolding 102 may be a mount supporting cradle 104. Scaffolding 102 may be operatively connected to optical breadboard 110.

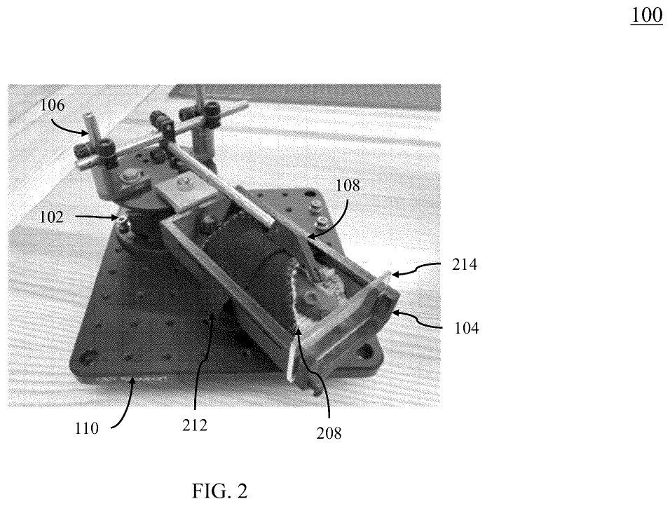

In some cases, the body holder may include swaddle 208 (depicted in FIG. 2) or a similar component that wraps around the animal's body, providing a comforting and secure restraint. In some aspects, the body holder may be designed to comfortably restrain the animal's body during the microscopy experiment. Swaddle 208 may wrap around the animal's body, providing a secure yet comfortable restraint. Swaddle 208 may be made of a soft, flexible material that conforms to the shape of the animal's body, reducing stress and discomfort to the animal. Swaddle 208 may be made of materials such as soft cotton, fleece, microfiber fabric, and/or another fabric or cloth. The material may be machine washable. These materials may provide a comfortable and gentle restraint for the animal. In some cases, elastic fabrics (e.g., spandex or elastane blends) may be used to allow for some movement while still maintaining a secure hold. Neoprene may also be utilized in some embodiments, as it can provide both flexibility and insulation. Breathable materials (e.g., bamboo fabric or moisture-wicking synthetic blends) may help regulate the animal's body temperature during extended imaging sessions. in some implementations, swaddle 208 may incorporate padding or cushioning in strategic areas to further enhance comfort. The choice of material may depend on factors such as the specific animal species, duration of the experiment, environmental conditions in the imaging setup, and/or other factors. Swaddle 208 may be adjustable to accommodate animals of different sizes and shapes. Swaddle 208 may be easily removed and replaced for cleaning or replacement. Swaddle 208 may be positioned/or shaped such that the animal's tail is free to move, the limbs of the animal are held close to its torso, and/or it extends to the neck of the animal. Swaddle 208 may comprise a hook and loop fastener (e.g., Velcro), a hook-and-eye clip, belt loops, and/or another fastener. The fastener may enable adjustability and maintenance of the tightness of the swaddle around the animal. The tightness of swaddle 208 around the animal may be adjusted depending on the comfort level and the size of the animal.

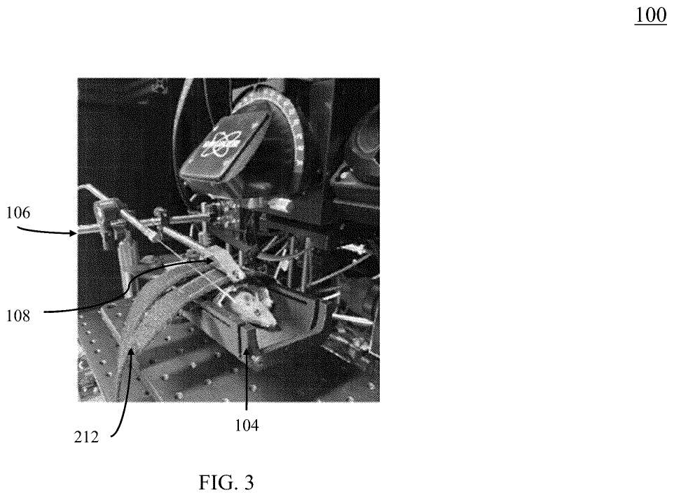

Cradle 104 may be designed to support the animal's body. Cradle 104 may be attached to the base. Cradle 104 may include slits or openings (e.g., as depicted in FIG. 2 and FIG. 3) for attaching a belt (e.g., belt 212 depicted in FIG. 2 and FIG. 3) or other restraint mechanism. Cradle 104 may be designed to provide a secure and stable platform for the animal, reducing unwanted movement during the microscopy experiment. In some implementations (not depicted), cradle 104 may be suspended in the air. In such implementations (not depicted), cradle 104 may be modeled after a swing. Such a cradle 104 may have a cut-out for each of the animal's limbs. In such implementations, the animal's limbs may be placed through the holes. In some implementations, swaddle 208 may similarly have holes for each of the animal's limbs. swaddle 208 and/or the animal may rest within cradle 104.

In some embodiments, cradle 104 may be designed to provide a comfortable and secure platform for the animal during the microscopy experiment. The cradle may be constructed from various materials, such as metal, plastic, or composite materials. The cradle may be designed to accommodate animals of different sizes and shapes. The cradle may include a concave or contoured surface that conforms to the shape of the animal's body, providing a snug and comfortable fit. In some cases, cradle 104 may be lined with a soft, cushioned material to enhance the comfort of the animal. The cradle may be attached to the base and may be adjustable to accommodate animals of different sizes and shapes. For example, cradle 104 may be an L-bracket.

Cradle 100 may comprise a window 210. Window 210 may or may not be removable. Window 214 may be configured to slide into a slot of cradle 104. Window 210 may prevent the animal from walking out of cradle 104. Window 210 may be transparent to enable a user to view the front of the animal. Window 210 may provide a clear view of the animal's body during the microscopy experiment, allowing for visual monitoring of the animal's behavior and physiological responses. Window 210 may be easily removed and replaced, facilitating cleaning and maintenance of the body holder. Window 210 being removable may also provide flexibility in the design of the body holder, enabling customization of the body holder to meet the specific needs of a given microscopy experiment. In some implementations, window 210 may be constructed of plexiglass, plastic, and/or another transparent material.

In some implementations, the body holder may comprise a treadmill in place of cradle 104. The treadmill may be configured in a manner that reduces friction. The treadmill may comprise a belt, two or more bearings, and/or other components. The use of a treadmill may enable the animal to adjust its posture. The use of a treadmill may facilitate experiments studying physical exercise. The use of a treadmill may result in difficulties stabilizing the animal's head for imaging and/or setting up auxiliary sensors.

The body holder may comprise a hamster wheel in place of cradle 104. The hamster wheel may be a traditional hamster wheel or a flying saucer hamster wheel. The traditional hamster wheel device is vertically oriented and allows the animal to run when there is minimal horizontal space. The flying saucer in comparison is horizontally oriented and allows the animal to run when there is minimal vertical space.

In some implementations, the body holder may comprise a claw in place of cradle 104. For example, the claw may be similar to and/or may be a claw as used in claw machine games. The claw may have a bucket shape for holding the animal's body in place during imaging. The claw may be hinged to enclose the animal. For example, the claw may be similar to and/or be a hair clip. For example, the shape of a hair clip may be modified to reduce the number of prongs. The claw may be designed such that the animal's limbs are enabled to fit within the empty space of the clip. In some implementations, the body holder is 3D printed. In some implementations, the claw comprises a safety switch. The safety switch may prevent harm to the animal in the case of one's hand slipping during set up or the device being tightened too quickly on the animal.

In some implementations, the body holder may comprise a cushion in place of cradle 104. By way of non-limiting example, the cushion may be modelled after a bean bag. The cushion may comprise a filling of air, beans, and/or another filler. The filler material may comprise many small pieces. The shape of the cushion may be adjustable by virtue of the material or composition of the filling. For example, the beans may be shuffled around to adjust the shape of the cushion. For example, the amount of filling in the cushion may be adjustable. The cushion may maintain a U-shape such that the animal rests deeply within the cushion. The use of a cushion for holding the body of the animal may enable the animal to adjust itself to a comfortable position.

### Base

In some implementations, system 100 may include several key components. One such component may be a base that supports system 100 during the microscopy experiment. The base may be designed to provide a stable platform for the body holder, head holder, and animal. The base may reduce unwanted movement that could interfere with the imaging process. The base may be constructed from various materials, such as metal or plastic. In some implementations, the distance between the base and the cranial window may be less than or equal to five inches.

The base may comprise optical breadboard 110 and/or adjustable stage 112. Optical breadboard 110 may be operatively connected to scaffolding 102. Adjustable stage 112 may provide a mechanism for adjusting the position of the animal's head and body in multiple axes. This feature may allow for precise positioning of the animal relative to the microscope, which can be crucial for obtaining high-quality microscopy images. Adjustable stage 112 may have a range of motion that allows for adjustments in the x, y, and z axes, providing a wide range of possible head and body positions. This level of adjustability can help align the animal's cranial window perpendicular to the microscope's optical axis, obtaining high-quality two-photon microscopy images. The fine-tuning capability of adjustable stage 112 helps compensate for small variations in animal size, cranial window placement, or initial positioning, ensuring optimal imaging conditions without the need to repeatedly handle or reposition the animal. Additionally, this range of motion can be useful for accessing different regions of interest within the cranial window by slightly tilting the animal's head, potentially expanding the area that can be imaged in a single experimental session. Adjustable stage 112 may be manually operated or may be controlled by a motor or other actuator. In some cases, adjustable stage 112 may include a locking mechanism to securely hold the animal's head and body at the desired position during the microscopy experiment.

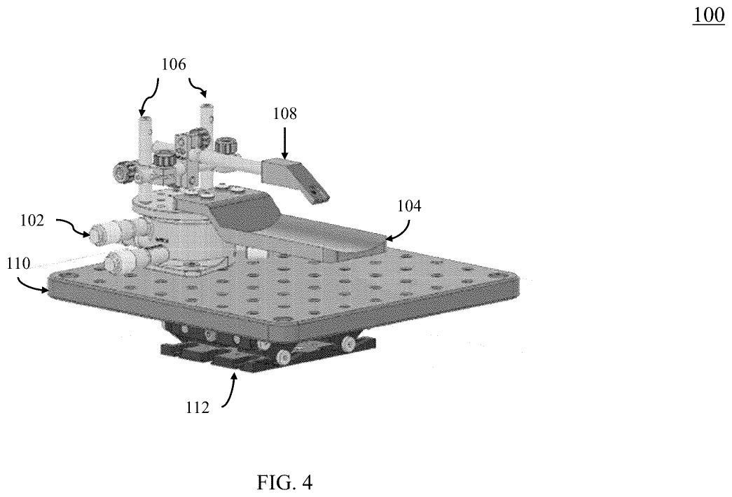

As depicted in FIGS. 1 and 4, adjustable stage 112 may comprise a scissor lifting jack. The scissor lifting jack may provide a mechanism for raising or lowering the base, and consequently the animal, to a desired height relative to the microscope. This feature may allow for precise positioning of the animal's cranial window at an optimal distance from the microscope objective, which can be crucial for obtaining high-quality microscopy images. The scissor lifting jack may be manually operated or may be controlled by a motor or other actuator. In some cases, the scissor lifting jack may include a locking mechanism to securely hold the base at the desired height during the microscopy experiment. The locking mechanism may prevent unwanted movement of the base, ensuring that the animal's cranial window remains at the desired distance from the microscope objective throughout the duration of the experiment.

Adjustable stage 112 may comprise other types of height adjustment mechanisms, such as a hydraulic lift, a pneumatic lift, a screw jack, or a rack and pinion mechanism. These alternative height adjustment mechanisms may offer different features or capabilities, such as higher load capacity, faster adjustment speed, or greater precision, which may be beneficial in certain microscopy experiments. The choice of height adjustment mechanism may depend on the specific requirements of the microscopy experiment, the characteristics of the animal, and/or other factors.

In some embodiments, the base may further include optical breadboard 110. Optical breadboard 110 plate may provide a flat, stable surface for supporting the animal. Optical breadboard 110 may serve as a platform for mounting various components of system 100, such as the head holder, body holder, and sensors. Optical breadboard 110 may be made of a material that is durable, easy to clean, and resistant to corrosion, such as aluminum or stainless steel. In some cases, optical breadboard 110 may be attached to the top surface of the base, providing a convenient and accessible platform for components of system 100 and/or system 700. By way of non-limiting example, optical breadboard 110 may be 6 inches by 18 inches. By way of non-limiting example, optical breadboard 110 may comprise a galvanized steel sheet.

In some embodiments, the base may also include a galvanized steel sheet attached to the top surface. The galvanized steel sheet may provide additional stability and rigidity to the base, enhancing the overall robustness of system 100. The galvanized steel sheet may also serve as a protective layer, shielding the underlying components of the base from potential damage or contamination during the microscopy experiment.

In some aspects, the base may include a custom-designed tip stage connected to the base. The tip stage may provide a mechanism for adjusting the position of the animal's head and body in multiple axes. This feature may allow for precise positioning of the animal relative to the microscope, which can be crucial for obtaining high-quality microscopy images. The tip stage may have a range of motion of #8 degrees, allowing for fine adjustments in the positioning of the animal. This range of motion provides researchers with the ability to make precise angular adjustments to the animal's position relative to the microscope objective. The +8-degree range allows for corrections in both positive and negative directions along multiple axes, typically pitch and roll. This level of adjustability helps align the animal's cranial window perpendicular to the microscope's optical axis, obtaining high-quality two-photon microscopy images. The fine-tuning capability of the tip stage helps compensate for small variations in animal size, cranial window placement, or initial positioning, ensuring optimal imaging conditions without the need to repeatedly handle or reposition the animal. Additionally, this range of motion can be useful for accessing different regions of interest within the cranial window by slightly tilting the animal's head, potentially expanding the area that can be imaged in a single experimental session. The tip stage may be manually operated or may be controlled by a motor or other actuator. In some cases, the tip stage may include a locking mechanism to securely hold the animal's head and body at the desired position during the microscopy experiment. The tip stage may be configured to tip, tilt, and/or rotate

### Head Holder

A head holder may be utilized to secure the animal's head. In some implementations, the head holder is operatively connected to the base. In some implementations, the head holder is operatively connected to scaffolding 102. The head holder may be designed to comfortably yet firmly hold the animal's head in a fixed position, minimizing head movement during the microscopy experiment. This may be particularly important in experiments involving two-photon microscopy, where even minor head movements can significantly affect the quality of the imaging data. The head holder may be adjustable, allowing for precise positioning of the animal's head relative to the microscope. In some implementations, the head holder may be configured to fixate the animal's head within five micrometers throughout an experiment. In some implementations, the head holder may be configured to allow the animal to move its head more than five micrometers during the experiment. In some aspects, the head holder may be designed to secure the animal's head in a fixed position during the microscopy experiment.

The head holder may comprise scaffolding 106 and mount 108. Scaffolding 106 may enable the head mount to be adjusted. Mount 108 may be a portion of the head holder configured to affix to the animal's head. Scaffolding 106 may include a ball joint that allows for angular adjustment of the animal's head position. This feature may provide flexibility in positioning the animal's head, enabling precise alignment of the animal's cranial window with the microscope objective. The ball joint may allow for rotation of the head holder about multiple axes, providing a wide range of possible head positions. This may be particularly beneficial in experiments involving two-photon microscopy, where precise positioning of the animal's head can significantly affect the quality of the imaging data. The head holder may comprise extension arms. The extension arms may be connected to either side of the ball joint. The extension arms may allow for an even greater amount of adjustability to the animal's head position under the microscope. The length of the extension arms may reduce the stability of the cranial window during imaging.

In some implementations, mount 108 may comprise a solid piece of metal. The solid piece of metal may fix the cranial window to the rest of the device. The head holder may comprise a screw. The screw may be used to attach the mouse to the head holder. In such implementations, the head holder may not be adjustable, but a rod attached to the head holder may be adjustable. In some implementations, the head holder may comprise an electromagnet in place of the screw. The electromagnet may enable gradual magnetization (and, therefore, gradual affixation of the animal's head). The electromagnet may require less time to attach the mouse to system 100 than the screw.

In some cases, scaffolding 106 may be constructed using a Newport scaffolding system. The Newport scaffolding system may provide a robust and adjustable framework for the head holder, allowing for precise positioning and secure attachment of the head holder to the base. The Newport scaffolding system may include various components, such as posts, clamps, and brackets, which can be assembled in a variety of configurations to accommodate different animal sizes and shapes. The use of the Newport scaffolding system may provide a high degree of flexibility and adaptability in the design of the head holder, enabling customization of the head holder to meet the specific needs of a given microscopy experiment.

In some implementations, mount 108 may comprise a clip-on mount. The clip-on mount may comprise a buckle securing the cranial window to the base without the use of a screw. Such a head holder may reduce set up time without the use of an electromagnet.

In some embodiments, the head holder may include a locking mechanism to securely hold the animal's head in the desired position during the microscopy experiment. The locking mechanism may be designed to prevent unwanted movement of the head holder once the animal's head has been positioned. This may help to maintain the alignment of the animal's cranial window with the microscope objective throughout the duration of the experiment, ensuring consistent and reliable imaging data.

In some cases, the head holder may be designed to comfortably yet firmly hold the animal's head, minimizing discomfort to the animal during the microscopy experiment. This may be achieved using soft or cushioned materials in the construction of the head holder, or through the design of the head holder to conform to the shape of the animal's head. Such design considerations may help to reduce stress and discomfort to the animal, potentially improving the quality of the imaging data and the overall success of the microscopy experiment. The head holder may include a clamp or other securing mechanism that can be adjusted to fit the size and shape of the animal's head. The head holder may be constructed from various materials, such as metal, plastic, or composite materials, and may be designed to minimize discomfort to the animal. In some cases, the head holder may include padding or cushioning to enhance the comfort of the animal. The head holder may be attached to the base or to cradle 104.

In some embodiments, the head holder may include a locking mechanism to securely hold the animal's head in the desired position during the microscopy experiment. The locking mechanism may be designed to prevent unwanted movement of the head holder once the animal's head has been positioned. This may help to maintain the alignment of the animal's cranial window with the microscope objective throughout the duration of the experiment, ensuring consistent and reliable imaging data.

In some cases, the head holder may be designed to minimize discomfort to the animal during the microscopy experiment. This may be achieved through the use of soft or cushioned materials in the construction of the head holder, or through the design of the head holder to conform to the shape of the animal's head. Such design considerations may help to reduce stress and discomfort to the animal, potentially improving the quality of the imaging data and the overall success of the microscopy experiment.

The head holder may be the closest element to a microscope's objective lens. The head holder may include materials capable of resisting thermal degradation from a laser (e.g., a laser used for two-photon excitation microscopy). The head holder may include materials with minimal reflectivity to enable compatibility with two-photon excitation microscopy.

### Sensor(s)

Referring to FIG. 7, a system 700 for positioning and monitoring animals during microscopy experiments in accordance with one or more embodiments of the present disclosure is depicted. System 700 may comprise system 100, a microcontroller 704, an ADC 710, and sensors. The sensors may comprise accelerometer 702, body camera 706, pupil camera 708, and/or one or more other sensors. The one or more other sensors may also include at least one sensor for measuring physiological parameters of the animal during the microscopy experiment. The sensors may be integrated with the base, head holder, body holder, or other components of system 700, and may be configured to measure various physiological parameters, such as body temperature, heart rate, respiration rate, or others. The sensor data may provide valuable information about the animal's physiological state during the experiment, which may be used to interpret microscopy or imaging data and may also be used to monitor the animal's well-being.

In some aspects, system 700 may include one or more sensors for measuring physiological parameters of the animal during the microscopy experiment. These sensors may be integrated with the base, head holder, body holder, or other components of system 700. The sensors may be configured to measure various physiological parameters, such as body temperature, heart rate, respiration rate, or others. The sensor data may provide valuable information about the animal's physiological state during the experiment, which may be used to interpret the microscopy data and may also be used to monitor the animal's well-being. In some implementations, the one or more sensors may comprise a thermometer configured to measure water temperature on the cranial window within 0.1° C. precision. In some implementations, the temperature may be sampled at a rate of at least 1 Hertz.

In some cases, the one or more sensors may include a detector configured for two-photon microscopy imaging. The two-photon microscopy imaging may be performed using a two-photon microscope, which may be positioned above the animal's head. The two-photon microscope may be configured to emit near-infrared light, which can penetrate the animal's cranial window and be absorbed by fluorophores in the animal's brain. The absorbed light may then be re-emitted as visible light, which can be detected by the microscope to generate high-resolution images of the animal's brain. System 700 may also incorporate one or more sensors for measuring physiological parameters of the animal during the microscopy experiment.

As depicted in FIG. 7, system 700 may comprise accelerometer 702 for detecting motion of the animal during the microscopy experiment. This feature may be particularly beneficial in experiments involving two-photon microscopy, where even minor movements of the animal can significantly affect the quality of the imaging data. The accelerometer may be attached to the head holder, body holder, or another component of system 700, and may be configured to measure motion in various directions. The accelerometer data may be used to monitor the animal's movement during the experiment, providing a means of detecting and quantifying any unwanted movement that could interfere with the imaging process. Accelerometer 702 may be integrated with the head holder, body holder, or another component of system 100. Accelerometer 702 may be configured to measure motion in various directions, providing a means of detecting and quantifying any unwanted movement of the animal that could interfere with the imaging process. Accelerometer 702 may continuously collect data. The data may be processed by the controller, providing real-time information about the animal's movement during the experiment.

In some embodiments, accelerometer 702 may be a three-axis accelerometer, capable of detecting motion in three dimensions. This feature may allow for more precise detection and quantification of the animal's movement, potentially enhancing the quality of the imaging data. A three-axis accelerometer may be configured to measure acceleration in the x, y, and z axes, providing a comprehensive view of the animal's movement. By way of non-limiting example, accelerometer 702 may be the BMZ250 sensor or another sensor.

In other cases, alternative types of motion sensors may be used, such as gyroscopes, tilt sensors, or optical motion sensors. These alternative motion sensors may offer different features or capabilities, such as higher accuracy, faster response times, or better performance in certain motion ranges, which may be beneficial in certain microscopy experiments. The choice of motion sensor may depend on the specific requirements of the microscopy experiment, the characteristics of the animal, and other factors.

In some embodiments, system 700 may comprise a thermocouple for measuring the temperature of the animal's cranial window. The thermocouple may be designed to provide accurate and reliable temperature measurements, which can be crucial for monitoring the animal's physiological state during the microscopy experiment. The thermocouple may be attached to the head holder, body holder, or another component of system 700, and may be positioned in close proximity to the animal's cranial window to ensure accurate temperature readings. The thermocouple data may be used to monitor the temperature of the cranial window during the experiment, providing a means of detecting and quantifying any changes in temperature that could affect the quality of the imaging data or the animal's well-being.

In other cases, alternative types of temperature sensors may be used, such as resistance temperature detectors (RTDs), thermistors, or infrared temperature sensors. These alternative temperature sensors may offer different features or capabilities, such as higher accuracy, faster response times, or better performance in certain temperature ranges, which may be beneficial in certain microscopy experiments. The choice of temperature sensor may depend on the specific requirements of the microscopy experiment, the characteristics of the animal, and other factors.

In some aspects, the at least one sensor may comprise at least one camera for capturing images or video of the animal during the microscopy experiment. The camera may be integrated with the base, head holder, body holder, or other components of system 700. The camera may be configured to capture high-resolution images or video of the animal, providing a visual record of the animal's behavior and physiological responses during the experiment. The camera data may be used to monitor the animal's behavior, providing a means of detecting and quantifying any changes in behavior that could affect the quality of the imaging data or the animal's well-being.

In some embodiments, system 700 may include two cameras. As depicted in FIG. 7, body camera 706 may be focused on the animal's body, capturing images or video of the animal's overall behavior and movement during the microscopy experiment. Body camera 706 may be positioned to provide a wide field of view, capturing the entire body of the animal. Pupil camera 708 may be focused on the animal's pupil, capturing images or video of the animal's eye movements and pupil dilation during the experiment. Pupil camera 708 may be positioned to provide a close-up view of the animal's eye, capturing detailed images or video of the pupil. The use of two cameras may provide a more comprehensive view of the animal's behavior and physiological responses, potentially enhancing the quality and interpretability of the microscopy data. The camera(s) may record at 30 frames per second. The camera(s) may record with a 720p resolution.

In some cases, the camera(s) may be or may be part of a camera subassembly. The camera subassembly may comprise at least one Raspberry Pi V2 camera module. These camera(s) are small, lightweight, and capable of capturing high-resolution images and video. They may be easily integrated with the base, head holder, body holder, or other components of system 700, and may be connected to the controller for data acquisition and processing. The Raspberry Pi V2 camera modules may provide a cost-effective and versatile solution for capturing images and video of the animal during the microscopy experiment.

In other embodiments, alternative camera modules may be used in the camera assembly, such as the Jetson Nano camera module, the BeagleBone Black camera module, the ODROID-C2 camera module, and/or other similar camera modules. These camera modules may offer different features or capabilities, such as higher resolution, faster frame rates, or better low-light performance, which may be beneficial in certain microscopy experiments. The choice of camera module may depend on the specific requirements of the microscopy experiment, the characteristics of the animal, and other factors.

In some cases, one or more cameras may be infrared cameras. Infrared cameras may be particularly useful for monitoring pupil dilation, as they can capture images or video in low-light conditions and can detect subtle changes in pupil size that may not be visible with standard cameras. The use of infrared cameras may provide a more accurate and reliable measure of pupil dilation, which can be an important indicator of the animal's physiological state during the microscopy experiment.

Monitoring pupil dilation may comprise reading a raw grayscale image captured by camera 708 pointed at the animal's eye(s). The image may be inverted such that each pixel value of the image is inverted. Thresholding may be applied to binarize the image. Areas and regions with low circularity may be removed to isolate the pupil region. In select frames, momentary whisker twitching may result in the pupil being blocked and/or inadvertently segmented into two parts. To correct this, the divided pupil region may be reconnected and fitted as an ellipse. The pupil diameter from the number of pixels spanning the smaller ais of the ellipse may be determined. The pupil diameter may be low-pass filtered. The filtering may be below 1 Hz with the fourth-order Butterworth filter.

In some embodiments, system 700 may include one or more sensors for measuring other physiological parameters of the animal. For example, system 700 may include a heart rate monitor for measuring the animal's heart rate, a respiration sensor for measuring the animal's respiration rate, or a blood oxygen sensor for measuring the animal's blood oxygen level. These additional sensors may be integrated with the base, head holder, body holder, or other components of system 700, and may be configured to measure the respective physiological parameters continuously or intermittently during the microscopy experiment. The data from these additional sensors may be collected and processed by the controller, providing further insights into the animal's physiological state during the experiment. In some implementations, one or more of the physiological parameters may be sampled at a rate of 30 Hz.

In some cases, the sensors may be miniaturized to minimize their impact on the animal's comfort and movement. The miniaturized sensors may be designed to be lightweight and compact, reducing their physical footprint and minimizing any discomfort or restriction they may cause to the animal. Despite their small size, the miniaturized sensors may be capable of providing accurate and reliable measurements of the respective physiological parameters.

In other embodiments, the sensors may be wireless, eliminating the need for physical connections between the sensors and the controller. The wireless sensors may communicate with the controller via a wireless communication protocol, such as Bluetooth, Wi-Fi, or another suitable wireless communication protocol. The use of wireless sensors may further enhance the animal's comfort and freedom of movement during the microscopy experiment, potentially improving the quality of the imaging data and the overall success of the experiment.

### Controller

System 700 may comprise a controller to receive and process data from the sensor or sensors. The controller may comprise a microcontroller, a computer, or another type of processing device, and may be configured to receive data from the sensor(s), process the data, and output the processed data for analysis or display. The controller may be configured to control various aspects of system 700, such as the position of the head holder or body holder, the operation of the microscope, or others. In some cases, the controller may be integrated with the base, head holder, body holder, or other components of system 700, or it may be a separate component. In some implementations, the controller may be configured to collect and store data from the video recording, any detected change in velocity from the animal, and/or other data.

In some aspects, system 700 may include a controller for receiving and processing data from the sensors. The controller may comprise a microcontroller 704, a computer, or another type of processing device, and may be configured to receive data from the sensors, process the data, and output the processed data for analysis or display. The controller may also be configured to control various aspects of system 700, such as the position of the head holder or body holder, the operation of the microscope, or others. In some cases, the controller may be integrated with the base, head holder, body holder, or other components of system 700, or it may be a separate component.

In some aspects, microcontroller 704 may be a Jetson Nano microcontroller, manufactured and sold by NVidia Corp. The Nvidia Jetson Nano microcontroller is a small, powerful computing device capable of performing multiple tasks simultaneously.

Microcontroller 704 may be configured to receive data from the sensors, process the data, and output the processed data for analysis or display. The Nvidia Jetson Nano microcontroller can handle large amounts of data, such as the data generated by the sensors during a microscopy experiment. Microcontroller 704 may also be capable of performing complex computations, such as those required for processing and analyzing the sensor data.

In other embodiments, microcontroller 704 may be one of several alternative microcontrollers such as: the Raspberry Pi 4 Model B, manufactured by Raspberry Pi Foundation (Cambridge, England, UK); Rock Pi 4, manufactured by Radxa (Shenzhen, Guangdong, China); Tinker Board S, manufactured by ASUSTeK Computer Inc. (Taipei, Taiwan); or the NanoPi M4, manufactured by FriendlyElec (Guangzhou, Guangdong, China).

In some cases, system 700 may include a graphical user interface (GUI) for controlling the sensors and viewing the data. The GUI may be displayed on a computer monitor or other display device and may provide a user-friendly interface for controlling various aspects of system 700. The GUI may include various controls for adjusting the settings of the sensors, initiating or stopping data collection, and viewing the collected data. The GUI may also include graphical representations of the sensor data, such as graphs or charts, which may provide a visual representation of the physiological parameters measured by the sensors. The GUI may be designed to be intuitive and easy to use, allowing researchers to control system 700 quickly and easily and to view the sensor data. In some embodiments, the GUI may be custom-written software that features a graphical user interface for displaying and recording the sensor data. The software's recordings may be triggered by another system, ensuring synchronous recordings from the device's peripheral sensors and the imaging microscope data.

In some implementations, the one or more sensors may be unified on a single breadboard. All data collected by the one or more sensors may be available to a user via a single GUI. Input may be provided via the GUI to microcontroller 704. Microcontroller 704 may transmit desired data to the GUI responsive to receiving the input. The GUI may enable a user to turn the camera feed on and off, to start and stop recording sensor data, to reset the sensor data, to stimulate the animal, to download sensor data, and/or to convert sensor data to a particular file type. For example, the file type may be MP4.

The GUI may comprise a user interface depicting a real-time display from the cameras. The GUI may facility automatic data retrieval. The data retrieval may be initiated by a 5V trigger signal. The GUI may comprise a user interface depicting data measured by the accelerometer during an experiment. The controller may be configured to store the sensor data as it is measured. After each experiment, the camera and accelerometer data may be reviewed.

System 700 may simultaneously monitor at least one physiological parameter of the animal using the sensor or sensors integrated with system 700. The physiological parameter(s) may include, for example, body temperature, heart rate, respiration rate, or others. The sensor data may be continuously collected and processed by the controller, providing real-time information about the animal's physiological state during the microscopy experiment.

In some embodiments, system 700 may be configured to trigger an alert or stop the microscopy experiment if the sensor data indicates a significant change in the animal's physiological state, such as a sudden increase in body temperature or heart rate. This feature may help to ensure the animal's well-being during the microscopy experiment, potentially reducing the risk of harm to the animal.

In other embodiments, system 700 may be configured to adjust the position of the animal's head or body in response to changes in the sensor data. For example, if the sensor data indicates that the animal is becoming uncomfortable or distressed, system 700 may adjust the position of the head holder or body holder to alleviate the discomfort or distress. This feature may help to maintain the animal's comfort and well-being during the microscopy experiment, potentially improving the quality of the imaging data and the overall success of the experiment.

In some cases, system 700 may also include a graphical user interface (GUI) for displaying the sensor data and controlling the microscopy experiment. The GUI may provide a user-friendly interface for viewing the sensor data, adjusting the settings of system 700, and controlling the operation of the two-photon microscope. The GUI may also include features for analyzing the sensor data, such as graphs, charts, or other visual representations of the data. This may allow researchers to easily monitor the animal's physiological state during the microscopy experiment and make adjustments as needed to optimize the imaging results.

In some aspects, system 700 may be configured to exclude microscopy data acquired during periods of excessive animal motion based on accelerometer readings. This feature may help to ensure the quality and reliability of the microscopy data, as unwanted movement of the animal can significantly affect the quality of the imaging data. The controller may be configured to monitor the accelerometer data in real-time and to automatically exclude microscopy data acquired during periods when the accelerometer data indicates excessive animal motion. This may allow for more accurate and reliable analysis of the microscopy data, potentially improving the overall success of the microscopy experiment. The accelerometer may detect any change in velocity of the mouse within 0.1 meters per second squared.

The controller may be configured to synchronize the sensors based on trigger signals. As depicted in FIG. 7, The controller may comprise a high-precision analog-to-digital converter chip (ADC) 710. For example, ADC 710 may be ADS1115 16-bit, Texas Instruments. ADC 710 may be connected to the microcomputer via an I2C interface to record trigger signals. ADC 710 may comprise 4 single-end input channels or 2 differential channels. In some implementations, a differential channel may represent the trigger signal to initiate stimulation trials. The other differential channel may record the trigger for individual functional stimuli.

### Stimuli

System 700 may include stimuli configured to stimulate the animal's whiskers. In some embodiments, the stimuli may comprise an air puff stimulus positioned to stimulate the mouse's whiskers. The air puff stimulus may be designed to evoke changes in cellular and hemodynamic activity in the mouse's brain, which can be observed and measured using the two-photon microscope. The air puff stimulus may be controlled by the controller, allowing for precise timing and intensity of the stimulus. The use of an air puff stimulus may provide a non-invasive and easily controllable method of evoking brain activity in the mouse, potentially enhancing the quality and interpretability of the microscopy data. For example, each air puff may last 0.3 seconds. For example, the air puffs may be initiated at a rate of 3 Hz. For example, the stimulation of the animal may last for 3 seconds.

The stimuli may comprise one or more electrodes. The one or more electrodes may comprise needle electrodes placed in one or more paws of the animal. The needle electrodes may be placed underneath the skin of the animal. In some implementations, the needle electrodes may be placed in the rear paws of the animal. Such a stimulus may cause pain to the animal. As a result, such a stimulus may only be used on an anesthetized animal. The one or more electrodes may comprise an intracranial electrode. The intracranial electrode may be surgically implanted in the animal. For example, an electrode may be implanted on the cortical surface of the animal.

The stimuli may comprise an optogenetic stimulus. Optogenetic stimulation works by exciting tissue via light-gated ion pumps or channels. Working as an alternative to electrical stimulation, optogenetics uses light to induce neuronal activity directly in the brain of awake subjects. Optogenetic stimulation may require an additional pre-imaging procedure, in which a cannula accommodating a miniature optical fiber is implanted in the brain of the mouse. The miniature optical fiber may be attached to an LED light source that can induce neuronal activity in the brain.

The stimuli may comprise a vibration. The vibration may be to one or more paws of the animal. The vibration may be to the animal's whiskers. The stimuli may be auditory and/or visual. For example, a visual stimulus may comprise drifting gratings.

### Set Up

Optical breadboard 110 may be fixed to the top of the scissor lifting jack. Optical breadboard 110 may be configured to hold the body holder, the head holder, the sensor(s), and/or other components. The tilt stage may be fixed to the top of optical breadboard 110. Scaffolding of the head holder may be fixed to optical breadboard 110. The controller may be fixed to the bottom of optical breadboard 110. The accelerometer may be placed as close to the animal's head as possible. The one or more cameras may be fixed to optical breadboard 110 during imaging. The cameras may be removable for transportation. The thermocouple may be placed off of the device. The probe of the thermocouple may be placed on a glass coverslip of the cranial window. The thermocouple and/or the probe of the thermocouple may be held by post clamps and/or holders.

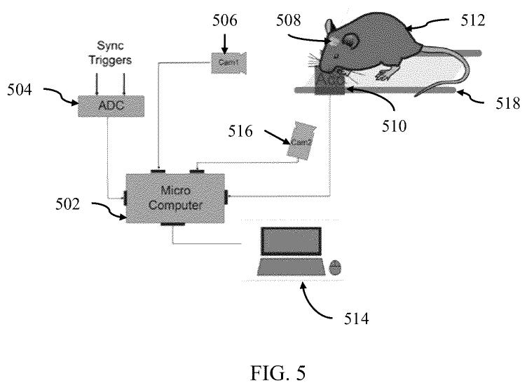

FIG. 5 depicts a schematic diagram of a system 500 for conducting imaging experiments on an animal. System 500 may comprise a positioning device 518, a camera 506, a camera 516, a client computing platform 514, a processor 502, an accelerometer 510, and an ADC 504. Positioning device 518 may comprise restrain an animal 512. Animal 512 may have an implanted cranial window 508. Accelerometer 510 may be placed near the animal's head. Accelerometer 510 may detect motion of the animal during the experiments. Camera 506 may be directed at the body of the animal. Camera 516 may be directed at one or both pupils of the animal. A user conducting an experiment may provide input to client computing platform 514 indicating sensor operation control. The user may review sensor data and/or perform other actions via client computing platform 514. Client computing platform 514 may comprise a display. The display may present one or more user interfaces to the user regarding such operations. Microcontroller 502 may adjust sensor operations based on the input provided to client computing platform 514. ADC 504 may be configured to synchronize sensors of system 500 (including camera 506, camera 516, and accelerometer 510) based on received synchronization triggers.

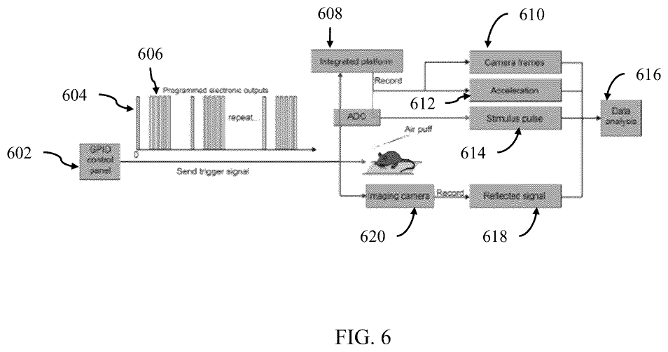

FIG. 6 depicts an exemplary flow diagram depicting a process 600 for synchronizing data acquisition during imaging of an animal. Pulse 604 (and other purple pulses) may signify the start of a new measurement trial in an experiment. Such pulses may trigger integrated platform 608 and optical imaging camera 620. Pulse 606 (and other green pulses) may trigger pneumatic stimulator 614 to deliver an air puff to the whiskers of the animal. Process 600 may comprise simultaneously starting operation of integrated platform 608, a pneumatic machine 614, and camera 620, and/or another component. Operation may start responsive to control panel 602 sending pulses to other components. Process 600 may comprise collecting data collected by camera 620, camera 610, accelerator 610, and/or another sensor. In some implementations, the frames recorded by camera 620 may comprise reflected signals 618. Process 600 may comprise performing data analysis 616 of the collected data.

Animals may need to be acclimated to the systems described herein prior to use of the systems for experimentation. A method for acclimating an animal may comprise acclimating the animal to the fabric of the swaddle. Acclimating the animal to the fabric may comprise placing the enclosed swaddle in the animal's enclosure. The method may comprise acclimating the animal to the swaddle and swaddle holder.

Acclimating the animal to the body holder may comprise resetting the scissor lifting jack to the lowest setting. Acclimating the animal to the body holder may comprise resetting the rotational platform to 0-degree tilt, 0-degree pitch, and 0-degree yaw. Acclimating the animal to the body holder may comprise raising the head holder (or a portion of the head holder). Acclimating the animal to the body holder may comprise fastening clips on the swaddle. Acclimating the animal to the body holder may comprise choosing the set of clips (small/large) appropriate for the animal's size. Acclimating the animal to the body holder may comprise laying the swaddle down on the cradle. Acclimating the animal to the body holder may comprise picking up the animal from its enclosure. Acclimating the animal to the body holder may comprise guiding the animal into the swaddle and positioning its legs according to the specified design (i.e. if design is for the hind legs to stick out of the swaddle, position legs through the snuggle sack holes). Acclimating the animal to the body holder may comprise ensuring the cranial window and head mount on the mouse's skull are external to the swaddle. Acclimating the animal to the body holder may comprise allowing the animal to walk into the swaddle. Acclimating the animal to the body holder may comprise securing the animal's position and strapping the belt in place to hold the animal in place. Acclimating the animal to the body holder may comprise securing the head post to the head fixture on the positioning device. The head post may be secured using a screw. Acclimating the animal to the body holder may comprise recording a duration of a portion of the acclimation process. The portion of the acclimation process may begin prior to fastening the clips. The portion may conclude upon securing the head post.

Acclimating the animal to the body holder may comprise adjusting the platform and head mount to maximize the animal's comfort. Acclimating the animal to the body holder may comprise allowing the animal to remain in the positioning device for 5 minutes while observing the animal's behavior. Acclimating the animal to the body holder may comprise recording the grimace score. Acclimating the animal to the body holder may comprise rewarding the mouse once the snuggle sack is fastened onto the positioning device. For example, the animal may be rewarded with sweetened condensed milk. The animal may be rewarded more than once. Acclimating the animal to the body holder may comprise unfastening the head post from the head fixture. Acclimating the animal to the body holder may comprise unfastening the belt strap and removing the swaddled animal from the positioning device. Acclimating the animal to the body holder may comprise removing the animal from the swaddle and returning it to its enclosure. Such acclimation steps may be repeated daily, increasing by 5-15 minutes each day. The acclimation steps may be repeated until the mouse stays in the device for 90 minutes on the last day of acclimation training. Acclimating the animal to the body holder may comprise capturing the animal's grimace score at designated time markers. Once the animals are acclimated to 90 minutes, a full experiment may be conducted. The device may be cleaned after each use.

A method for preparing to conduct a microscopy experiment may comprise resetting the scissor lifting jack to the lowest setting. The method may comprise resetting the rotational platform to 0-degree tilt, 0-degree pitch, and 0-degree yaw. The method may comprise raising the head holder (or a portion of the head holder). The method may comprise directing a camera at the body of the animal. The method may comprise directing the one or more stimuli at the animal's whiskers. The method may comprise directing the accelerometer at the animal's head. The method may comprise connecting all sensors to the controller. The method may comprise placing each sensor and stimulus in place on the optical breadboard. The method may comprise determining the weight of the animal. The method may comprise starting a stopwatch to record the duration of the preparation. The method may comprise determining a set of clips based on the size of the animal. The method may comprise fastening clips on the swaddle. The method may comprise laying the swaddle in the swaddle holder. The method may comprise ensuring the sliding panel of the swaddle holder is in place. The method may comprise removing the animal from its enclosure. The method may comprise guiding the animal into the swaddle. The method may comprise positioning the animal's limbs according to the specified design. The method may comprise ensuring cranial window and the head mount on the animal's skull is outside of the swaddle. The method may comprise enabling the animal to walk into the swaddle. The method may comprise securing the head post to the head mount using a screw. The method may comprise adjusting the height, pitch, and yaw of the device to ensure the cranial window is parallel to the microscope objective lens. The method may comprise adjusting the positioning of the device as needed. The method may comprise stopping the stopwatch. The method may comprise placing water on the animal's cranial window. The water may be used to ensure a more accurate reading of the animal's temperature by the thermocouple.

The method may comprise positioning the thermometer (or a thermocouple probe) on the cranial window of the animal. The method may comprise operating a microscope with the laser off. The laser may be off to familiarize the animal with the sounds and sights associated with imaging experiments. The method may comprise activating the one or more stimuli on the animal's whiskers. In some implementations, the exposure to the device and stimuli may be carried out for progressively longer durations every day for 7 days. By way of non-limiting example, the exposure to the stimuli may be increased from 5 minutes to 45 minutes throughout the acclimation period. The method may comprise determining the grimace score of the animal.

The method may comprise unscrewing the animal from the head holder. The method may comprise cleaning the device after each use.

In some cases, the process of positioning and securing the animal in the restraint device may be performed manually by a researcher. In other cases, the process may be automated or semi-automated, with the base, head holder, and body holder being adjusted and controlled by a controller or other control mechanism. The controller may receive input from the researcher or from sensors integrated with the restraint device, and may adjust the position of the base, head holder, and body holder based on this input. This may allow for precise and consistent positioning and securing of the animal in the restraint device, potentially improving the quality and repeatability of the microscopy experiments. In some implementations, adjustable components may lock with a torque between four and six Newtons per meter.

A number of implementations have been described. Nevertheless, it will be understood that various modifications may be made without departing from the spirit and scope of the disclosure. Accordingly, other implementations are within the scope of the following claims.

### Test of Rapid Screening of Motion Artifacts

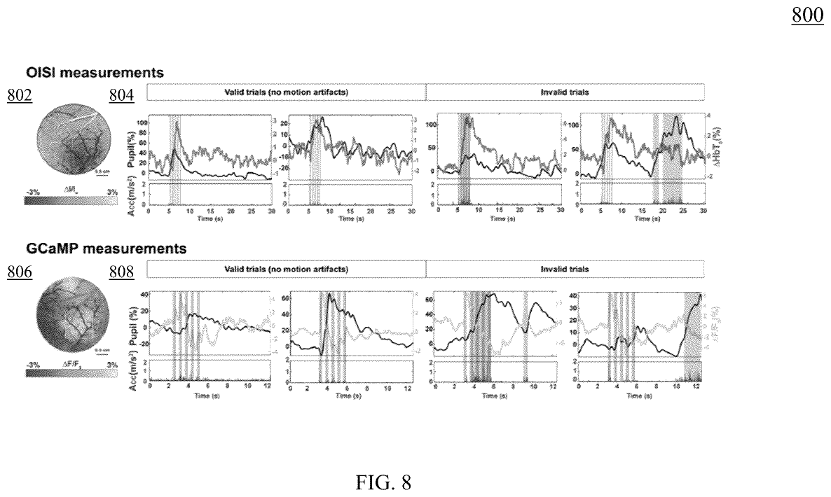

Tests of the utility of the devices described herein to quickly detect motion artifacts during functional stimulation experiments were conducted. The somatosensory cortices of awake Thy-1 GCaMP mice were imaged with the WFOI setup while the integrated device monitored their behavior and measured pupil diameter. Imaging sessions were performed to monitor stimulus-induced changes (pneumatic whisker deflection, 300 millisecond air puff, 3 Hz stimulus train, 3 seconds duration per trial) in blood volume by optical intrinsic signal (OIS) (reflectance measurements λ=568±10 nm, 5 frames per second, 30 seconds per trial) and, in separate imaging sessions, changes in neuronal calcium dynamics were monitored by GCaMP fluorescence (fluorescence measurements λₑₓ=470±40 nm, λₑₘ=525±50 nm, 20 frames per second, 12.5 seconds per trial). To exclude experimental trials confounded by motion, the acceleration was screened in 0.5 second intervals. A motion artifact was defined as an event that caused the acceleration reading to exceed 0.2 m/s² for more than 6 non-consecutive data points within a single 0.5 s time interval. FIG. 8 displays representative results from individual imaging trials with and without confounding motion artifacts. As anticipated, pneumatic whisker deflection provoked dynamic, local increases in both hemodynamics and neural activity (FIG. 8, image 802 and graphs 804). Image 802 depicts OIS imaging of the functional hyperemia center (red rectangle) in the barrel cortex through a 3 mm cranial window. Graphs 804 depict four representative trials showing 30-second time courses of total hemoglobin change, pupil diameter, and acceleration. A corresponding, stimulus-evoked increase in pupil diameter was observed for each stimulation trial. Four representative trials of OIS measurements lasting 30 seconds are displayed in graphs 804, and four trials of GCaMP calcium signal measurements of 12.5-second durations are featured in graphs 808. Image 806 depicts GCaMP imaging of the neural activity center (green rectangle) through the same cranial window as used to capture image 802. As expected, local blood volume (ΔHbT), neuronal GCaMP signaling (ΔF/F₀), and pupil diameter returned to the resting state after the stimulus in trials where no motion was detected. However, for the trials affected by animal motion, the acceleration fluctuated dramatically, and the optical measurement results altered unexpectedly. In addition, in the presence of disruptive motion artifacts, pupil dilation persisted for a longer duration, reflecting initiation of the animal's fight-or-flight response.

Correlating Pupillary Response with Cortical Hemodynamics and Neuronal Calcium

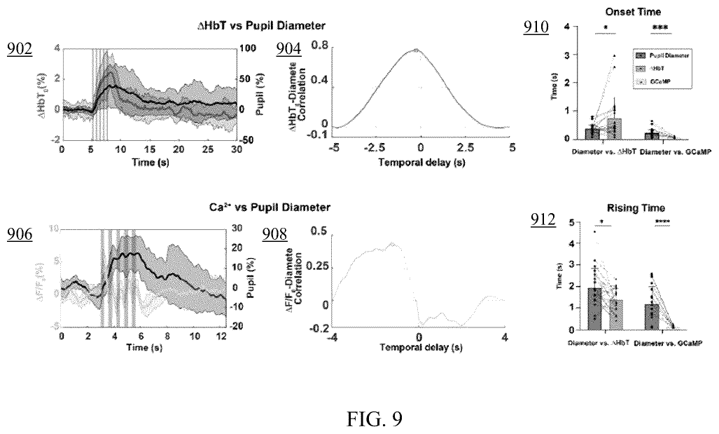

The devices' performance was tested by analyzing and correlating kinetic features of functional imaging data collected with WFOI and the integrated device. In particular, the ability of the device to not skew experiments due to biasing the animal was measured. Specifically, the stimulus-induced pupillometry changes acquired from an exemplary device were correlated with vascular and neuronal measurements from the cortex acquired with WFOI. The data were first screened to remove trials corrupted by spontaneous motion artifacts. Block-averaged time courses of OIS versus pupil diameter and GCaMP versus pupil diameter are displayed in graph 902 and graph 906 depicted in FIG. 9. As expected, whisker stimulation evoked an increase in blood volume that returned to baseline level shortly after the stimulus train completed. Neural activity increased more rapidly in response to each stimulus (graph 902). With the repetition of stimuli, the peak of the calcium signal gradually reduces (from ˜5% to ˜1%) due to partial blood volume effect (graph 906). The pupil diameter increased over the course of the 3-second stimulus train and returned to baseline within 3-7 seconds.

We analyzed the temporal relationships between stimulus-induced pupil dilation and cortical hemodynamics, and the relationships between pupil dilation and neuronal Ca2+, respectively. We calculated the cross-correlation between these combinations of signals as well as the onset time and rise time of each signal from graph 904 and graph 908 depicted in FIG. 9. The pupil diameter measurement was detrended before cross-correlation. The rising time was defined as the time from 10% to 90% of the peak height after the beginning of the first stimulus, and the onset time was defined as the beginning of the first stimulus to 10% of the peak height.

FIG. 4. relates the kinetics of stimulus-induced pupillary dilation and cortical blood volume. As expected, the responses of cortical blood volume and pupil dilation were strongly correlated (0.77+0.0033). Interestingly, both cross-correlation and onset time analysis indicate that, on average, pupil dilation initiates nearly 300 milliseconds before the change in cortical blood volume (graph 904 and graph 910). As for rising time, pupil diameter and OIS reached 90% of the peak after 1.957+0.928 seconds and 1.397+0.558 seconds, respectively (graph 912 depicted in FIG. 9). The results indicate that, while pupillary dilation initiates earlier than vascular changes in the cortex, pupillary dilation takes longer than cortical blood volume to reach its stimulus-induced peak.

As expected, pupil diameter changes also correlated well with evoked increases in neuronal calcium, with a notable correlation of 0.43±0.014 (graph 908). However, the kinetic features of each signal differed considerably. Neuronal calcium increased and decreased rapidly in response to each individual stimulus pulse, while the pupil dilated more gradually as the stimulus train persisted. The calculations indicate that the onset time of neuronal GCaMP fluorescence occurred earlier than that of the pupil (graph 912). The rise time for GCaMP (0.09±0.03 s) was also considerably shorter than pupillary dilation (0.283±0.15, graph 910 depicted in FIG. 9).

Graph 902 depicts the trial averaged results of ΔHbT vs. Pupil diameter. Graph 906 depicts the trial averaged results of GCaMP vs. Pupil diameter in response to whisker stimulation. Gray shaded bars represent whisker stimulus pulse. 20 trials were used for graph 902 and 16 trials were used for graph 906. Graph 908 depicts cross-correlation between changes in total hemodynamic changes and pupil diameter 5 s after stimulus onset. The red dot indicates the peak correlation value. Graph 910 depicts cross-correlation between GCaMP fluorescence and pupil diameter 4 seconds after stimulus onset. The shaded areas in graph 904 and graph 908 indicate standard error measurements. The green dot depicted in graph 908 indicates the maximum correlation location. Graph 910 and graph 912 depict the rising time and onset time comparisons between pupil diameter and optical results. Statistical difference was tested using Student's t-test (mean±SD).

Various modifications to the implementations described in this disclosure may be readily apparent to those skilled in the art, and the generic principles defined herein may be applied to other implementations without departing from the spirit or scope of this disclosure. Thus, nothing in this specification is intended to imply that any feature, characteristic, or attribute of the disclosed systems and processes is essential.

Certain features that are described in this specification in the context of separate implementations can also be combined in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together into a single software product or packaged into multiple software products.

1. A system for positioning and monitoring an animal during microscopy, comprising:
a base supporting the animal;
a head holder attached to the base and securing the animal's head;
a body holder attached to the base and restraining the animal's body;
at least one sensor measuring a physiological parameter of the animal;
a microscopy system configured to record images of the animal; and
a controller receiving and processing data from the at least one sensor.

2. The system of claim 1, wherein the microscopy system is a two-photon excitation microscopy system.

3. The system of claim 1, wherein the base comprises a scissor lifting jack adjusting the height of the animal.

4. The system of claim 1, wherein the head holder comprises a ball joint allowing angular adjustment of the animal's head position.

5. The system of claim 1, wherein the body holder comprises a fabric swaddle restraining the animal's body.

6. The system of claim 1, wherein the at least one sensor comprises an accelerometer detecting motion of the animal.

7. The system of claim 6, wherein the controller is configured to:
identify, based on the motion of the animal, a period of excessive animal movement; and
exclude images collected by the microscopy system during the period.

8. The system of claim 1, wherein the at least one sensor comprises a thermocouple measuring a temperature of a cranial window implanted in the animal.

9. The system of claim 1, wherein the at least one sensor comprises a camera capturing images of the animal during microscopy.

10. A method for imaging an awake animal using two-photon microscopy, comprising:
positioning the animal in a restraint device comprising a base, a head holder, and a body holder;
securing the animal's head with the head holder;
restraining the animal's body with the body holder;
measuring at least one physiological parameter of the animal using at least one sensor; and
performing two-photon microscopy imaging on the animal while simultaneously monitoring the at least one physiological parameter.

11. The method of claim 10, wherein measuring the at least one physiological parameter comprises measuring a temperature of the animal's cranial window using a thermocouple.

12. The method of claim 10, further comprising adjusting a height of the base to position the animal's cranial window at a desired distance from a microscope objective.

13. The method of claim 12, wherein adjusting the height of the base comprises operating a scissor lifting jack.

14. The method of claim 10, wherein measuring the at least one physiological parameter comprises detecting motion of the animal using an accelerometer.

15. The method of claim 10, further comprising excluding microscopy data acquired during periods of excessive animal motion based on accelerometer readings.

16. The method of claim 10, further comprising capturing images or video of the animal during microscopy imaging using at least one camera.

17. A device for restraining and monitoring an animal during microscopy, comprising:
a swaddle restraining the animal's body;
a cradle supporting the animal's body and the swaddle;
a head holder securing the animal's skull;
an adjustable stage connected to the head holder, the adjustable stage providing multi-axis positioning; and
at least one sensor integrated with the device and measuring a physiological parameter of the animal during microscopy.

18. The device of claim 17, wherein the adjustable stage comprises a scissor lifting jack adjusting a vertical position of the animal.

19. The device of claim 17, wherein the at least one sensor comprises an accelerometer detecting motion of the animal.

20. The device of claim 17, wherein the at least one sensor further comprises a thermocouple measuring a temperature of the cranial window.

21. The device of claim 17, further comprising at least one camera capturing images or video of the animal during microscopy.

22. The device of claim 19, wherein the at least one camera comprises an infrared camera monitoring pupil dilation of the animal.
